(19) United States
(12) Patent Application Publication
(10) Pub. No.: US 2015/0220871 A1
(43) Pub. Date: Aug. 6, 2015

(54) METHODS AND SYSTEMS FOR SCHEDULING A BATCH OF TASKS

(71) Applicant: XEROX CORPORATION, Norwalk, CT (US)

(72) Inventors: Vaibhav Rajan, Bangalore (IN); Sakyajit Bhattacharya, Bangalore (IN); Koustuv Dasgupta, Bangalore (IN); Nischal Murthy Piratla, Fremont, CA (US); Laura Elisa Celis, Bangalore (IN); Deepthi Chander, Cochin (IN); Saraschandra Karanam, Bangalore (IN)

(73) Assignee: XEROX CORPORATION, Norwalk, CT (US)

(21) Appl. No.: 14/171,793

(22) Filed: Feb. 4, 2014

(51) Int. Cl. G06Q 10/06

(52) U.S. Cl. CPC G06Q 10/063112

(57) ABSTRACT

The disclosed embodiments illustrate methods and systems for scheduling a batch of tasks on one or more crowdsourcing platforms. The method includes generating one or more forecast models for each of the one or more crowdsourcing platforms based on historical data associated with each of the one or more crowdsourcing platforms and a robustness parameter. Thereafter, for a forecast model, from the one or more forecast models, associated with each of the one or more crowdsourcing platforms, a schedule is generated based on the forecast model and one or more parameters associated with the batch of tasks. Further, the schedule is executed on each of the one or more forecasts models associated with the one or more crowdsourcing platforms to determine a performance score of the schedule on each of the one or more forecast models. Finally, the schedule is recommended to a requestor based on the performance score.

### TECHNICAL FIELD

The presently disclosed embodiments are related, in general, to crowdsourcing. More particularly, the presently disclosed embodiments are related to methods and systems for scheduling a batch of tasks on one or more crowdsourcing platforms.

### BACKGROUND

With the emergence and the growth of crowdsourcing technology, a large number of organizations and individuals are crowdsourcing tasks to workers through crowdsourcing platforms. Some of the important considerations while crowdsourcing of large batches of tasks include questions such as which crowdsourcing platforms are suitable for a batch of tasks and how to schedule the batch of tasks on these crowdsourcing platforms. Further, task accuracy and task completion time of workers associated with a crowdsourcing platform may vary significantly over different hours in a day and over different days in a week. Therefore, performance of the workers over an extended period may be unpredictable. Hence, it may be difficult to effectively select crowdsourcing platforms and subsequently schedule the batch of tasks on the selected crowdsourcing platforms over a period.

### SUMMARY

According to embodiments illustrated herein, there is provided a method for scheduling a batch of tasks on one or more crowdsourcing platforms. The method comprises determining, by one or more processors, one or more forecast models for each of the one or more crowdsourcing platforms based on historical data associated with each of the one or more crowdsourcing platforms and a robustness parameter. Thereafter, for a forecast model, from the one or more forecast models, associated with each of the one or more crowdsourcing platforms, a schedule is generated by the one or more processors based on the forecast model and one or more parameters associated with the batch of tasks. The schedule is deterministic of the processing of the batch of tasks on the one or more crowdsourcing platforms. Further, the schedule is executed, by the one or more processors, on each of the one or more forecasts models associated with the one or more crowdsourcing platforms to determine a performance score of the schedule on each of the one or more forecast models. Finally, the schedule is recommended to a requestor by the one or more processors based on the performance score.

According to embodiments illustrated herein, there is provided a system for scheduling a batch of tasks on one or more crowdsourcing platforms. The system includes one or more processors that are operable to determine one or more forecast models for each of the one or more crowdsourcing platforms based on historical data associated with each of the one or more crowdsourcing platforms and a robustness parameter. Thereafter, for a forecast model, from the one or more forecast models, associated with each of the one or more crowdsourcing platforms, a schedule is generated based on the forecast model and one or more parameters associated with the batch of tasks. The schedule is deterministic of the processing of the batch of tasks on the one or more crowdsourcing platforms. Further, the schedule is executed on each of the one or more forecasts models associated with the one or more crowdsourcing platforms to determine a performance score of the schedule on each of the one or more forecast models. Finally, the schedule is recommended to a requestor based on the performance score.

According to embodiments illustrated herein, there is provided a computer program product for use with a computing device. The computer program product comprises a non-transitory computer readable medium, the non-transitory computer readable medium stores a computer program code for scheduling a batch of tasks on one or more crowdsourcing platforms. The computer readable program code is executable by one or more processors in the computing device to determine one or more forecast models for each of the one or more crowdsourcing platforms based on historical data associated with each of the one or more crowdsourcing platforms and a robustness parameter. Thereafter, for a forecast model, from the one or more forecast models, associated with each of the one or more crowdsourcing platforms, a schedule is generated based on the forecast model and one or more parameters associated with the batch of tasks. The schedule is deterministic of the processing of the batch of tasks on the one or more crowdsourcing platforms. Further, the schedule is executed on each of the one or more forecasts models associated with the one or more crowdsourcing platforms to determine a performance score of the schedule on each of the one or more forecast models. Finally, the schedule is recommended to a requestor based on the performance score.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Furthermore, the elements may not be drawn to scale.

Various embodiments will hereinafter be described in accordance with the appended drawings, which are provided to illustrate the scope and not to limit it in any manner, wherein like designations denote similar elements, and in which:

FIG. 1 is a block diagram of a system environment in which various embodiments can be implemented;

FIG. 2 is a block diagram that illustrates a system for scheduling a batch of tasks on one or more crowdsourcing platforms, in accordance with at least one embodiment;

FIG. 3A and FIG. 3B together constitute a flowchart that illustrates a method for scheduling a batch of tasks on one or more crowdsourcing platforms, in accordance with at least one embodiment;

FIG. 4 is a flowchart that illustrates a method for ranking a one or more schedules, in accordance with at least one embodiment; and

FIG. 5 is a process flow diagram that illustrates a method for scheduling a batch of tasks on one or more crowdsourcing platforms, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment”, “at least one embodiment”, “an embodiment”, “one example”, “an example”, “for example”, and so on, indicate that the embodiment(s) or example(s) may include a particular feature, structure, characteristic, property, element, or limitation, but that not every embodiment or example necessarily includes that particular feature, structure, characteristic, property, element, or limitation. Furthermore, repeated use of the phrase “in an embodiment” does not necessarily refer to the same embodiment.

### DEFINITIONS

The following terms shall have, for the purposes of this application, the meanings set forth below.

A “task” refers to a piece of work, an activity, an action, a job, an instruction, or an assignment to be performed. Tasks may necessitate the involvement of one or more workers. Examples of the task include, but are not limited to, digitizing a document, generating a report, evaluating a document, conducting a survey, writing a code, extracting data, translating text, and the like.

“Crowdsourcing” refers to distributing tasks by soliciting the participation of loosely defined groups of individual crowdworkers. A group of crowdworkers may include, for example, individuals responding to a solicitation posted on a certain website such as, but not limited to, Amazon Mechanical Turk, Crowd Flower, or Mobile Works.

A “crowdsourcing platform” refers to a business application, wherein a broad, loosely defined external group of people, communities, or organizations provide solutions as outputs for any specific business processes received by the application as inputs. In an embodiment, the business application may be hosted online on a web portal (e.g., crowdsourcing platform servers). Examples of the crowdsourcing platforms include, but are not limited to, Amazon Mechanical Turk, Crowd Flower, or Mobile Works.

A “crowdworker” refers to a workforce/worker(s) that may perform one or more tasks, which generate data that contributes to a defined result. According to the present disclosure, the crowdworker(s) includes, but is not limited to, a satellite center employee, a rural business process outsourcing (BPO) firm employee, a home-based employee, or an internet-based employee. Hereinafter, the terms “crowdworker”, “worker”, “remote worker”, “crowdsourced workforce”, and “crowd” may be interchangeably used.

“Historical data associated with one or more crowdsourcing platforms” refers to at least information pertaining to a performance of each of the one or more crowdsourcing platforms over a period of time. Such information pertaining to the performance may be collected at regular intervals from each of the one or more crowdsourcing platforms. In an embodiment, the historical data may further include information related to the tasks such as, but not limited to, time spent by the crowdworkers on the one or more tasks, a count of the one or more tasks, wages earned/offered for the one or more tasks, types of the one or more tasks (e.g., digitization, translation, labeling, etc.), etc. Further, information about the crowdworkers, the requestors, and the crowdsourcing platforms may also be included in the historical data.

“Performance of a crowdsourcing platform” refers to a degree of efficiency of the crowdsourcing platform while processing a batch of task uploaded on the crowdsourcing platform. The performance of the crowdsourcing platform may be determined in terms of performance parameters of the crowdsourcing platform that correspond to at least one of a task accuracy, a task completion time, or a task cost.

“One or more parameters associated with a batch of tasks” refer to one or more parameters received from the requestor along with the batch of tasks. In an embodiment, the one or more requirement parameters associated with the batch of tasks comprise at least one of an expected task accuracy, a batch cost, an expected task completion time, or an expected batch completion time. The one or more parameters associated with the batch of tasks are interchangeably referred as one or more requirement parameters. In an embodiment, the one or more requirement parameters may correspond to an SLA associated with the batch of tasks.

An “expected task accuracy” refers to an average accuracy (usually in percentage) desired by the requestor on the tasks within the batch of tasks. In an embodiment, the accuracy, in general, corresponds to a ratio of number of correct responses received for a task from the one or more crowdworkers, to the total responses received from the one or more crowdworkers.

A “batch cost” refers to a maximum cost that the requestor is willing to bear for the processing of the entire batch of tasks on the one or more crowdsourcing platforms.

An “expected task completion time” refers to an average time that may be expended by the one or more crowdsourcing platforms for processing each task within the batch of tasks, as required by the requestor.

An “expected batch completion time” refers to a deadline that the requestor associates with the processing of the entire batch of tasks. Thus, the requestor may require the batch of tasks to be processed on the one or more crowdsourcing platforms at most by the expected batch completion time.

A “forecast model” refers to a mathematical model of a crowdsourcing platform. In an embodiment, the mathematical model may be representative of the behavior of the crowdsourcing platform. For example, the mathematical model may be representative of the performance of the crowdsourcing platform. Further, in an embodiment, the mathematical model may correspond to one or more time series distributions of the performance parameters of the crowdsourcing platform over a period of time. In an embodiment, the forecast model may be utilized to generate a schedule for scheduling the batch of tasks on the one or more crowdsourcing platforms.

A “granularity of a time series distribution” refers to a sampling interval at which individual samples of data are present in the time series distribution. For e.g., if the granularity of the time series distribution is a “per hour” granularity, the individual samples of data of this time series are sampled on a per hour basis.

A “robustness parameter” refers to a parameter received from the requestor, which may be used to generate the forecast models. Accordingly, in an embodiment, the robustness parameter may be a basis for determining a number of forecast models required to be generated from each mathematical model associated with the one or more crowdsourcing platforms. Thus, in an embodiment, higher the robustness parameter, greater the number of forecast models generated from each mathematical model. Further, each such forecast model may generated by systematically varying the mathematical model.

A “schedule” refers to a sequence of operations deterministic of processing the batch of tasks on the one or more crowdsourcing platforms. In an embodiment, a schedule may be generated based on forecast models associated with each of the one or more crowdsourcing platforms.

A “performance score of a schedule” refers to the performance of the one or more crowdsourcing platforms, determined by executing the schedule on a forecast model. In an embodiment, the performance score of the schedule may be determined based on at least one of a task accuracy, a task completion time, or a task cost.

A “confidence score” refers to an efficiency of a schedule on the one or more forecast models generated for each of the one or more crowdsourcing platforms. In an embodiment, the confidence score for the schedule may be determined based on the performance score and a predetermined threshold. The predetermined threshold corresponds to a value associated with the performance scores of the schedule on each of the one or more forecast models.

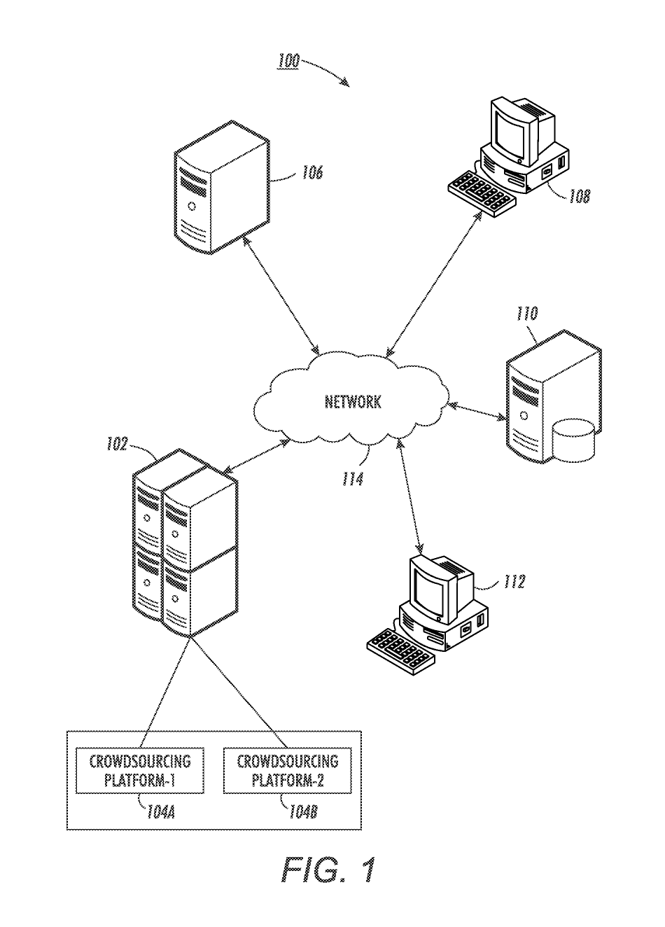

FIG. 1 is a block diagram of a system environment 100, in which various embodiments can be implemented. The system environment 100 includes a crowdsourcing platform server 102, an application server 106, a requestor-computing device 108, a database server 110, a worker-computing device 112, and a network 114.

In an embodiment, the crowdsourcing platform server 102 is operable to host one or more crowdsourcing platforms (e.g., a crowdsourcing platform-1 104A and a crowdsourcing platform-2 104B). One or more workers are registered with the one or more crowdsourcing platforms. Further, the crowdsourcing platform (such as the crowdsourcing platform-1 104A or the crowdsourcing platform-2 104B) processes one or more tasks by offering the one or more tasks to the one or more workers. In an embodiment, the crowdsourcing platform (e.g., the crowdsourcing platform-1 104A) presents a user interface to the one or more workers through a web-based interface or a client application. The one or more workers may access the one or more tasks through the web-based interface or the client application. Further, the one or more workers may submit a response to the crowdsourcing platform (e.g., the crowdsourcing platform-1 104A) through the user interface. In an embodiment, the crowdsourcing platform server 102 may monitor a performance of each of the one or more crowdsourcing platforms while the one or more crowdsourcing platforms process the one or more tasks. In another embodiment, the one or more crowdsourcing platforms may monitor their respective performances while processing the one or more tasks. Further, in an embodiment, the crowdsourcing platform server 102 may send information pertaining to the monitored performance of each of the one or more crowdsourcing platforms to the application server 106. In an embodiment, the crowdsourcing platform server 102 may receive a request from the application server 106 to process a batch of tasks on the one or more crowdsourcing platforms based on a schedule. In response to such a request, the crowdsourcing platform server 102 may send the batch of tasks to the one or more crowdsourcing platforms for processing based on the schedule. Subsequently, the one or more crowdsourcing platforms may process the batch of tasks by offering tasks within the batch of tasks to the one or more workers.

A person skilled in the art would understand that though FIG. 1 illustrates the crowdsourcing platform server 102 as hosting only two crowdsourcing platforms (i.e., the crowdsourcing platform-1 104A and the crowdsourcing platform-2 104B), the crowdsourcing platform server 102 may host more than two crowdsourcing platforms without departing from the spirit of the disclosure.

In an embodiment, the crowdsourcing platform server 102 may be realized through an application server such as, but not limited to, a Java application server, a .NET framework, and a Base4 application server.

In an embodiment, the application server 106 is operable to generate a mathematical model for each of the one or more crowdsourcing platforms based on historical data associated with each of the one or more crowdsourcing platforms. In an embodiment, the application server 106 may receive the historical data associated with each of the one or more crowdsourcing platforms from the crowdsourcing platform server 102. Further, in an embodiment, the historical data associated with each of the one or more crowdsourcing platforms corresponds to at least the performance of each of the one or more crowdsourcing platforms over a period of time. The application server 106 may generate the mathematical models by utilizing one or more statistical techniques such as, but not limited to, Auto Regressive Moving Average (ARMA) based modeling, least-square curve fitting algorithm, Bayesian Information Criteria (BIC), or any other statistical technique known in the art.

A person skilled in the art would understand that the scope of the disclosure is not limited to the generation of the mathematical model by the application server 106. In an alternate embodiment, the crowdsourcing platform server 102 or the database server 110 may generate the mathematical model.

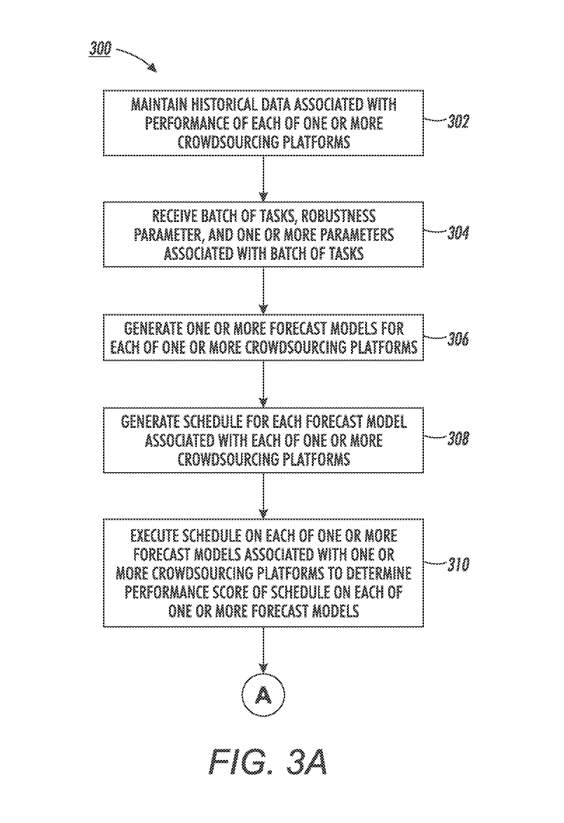

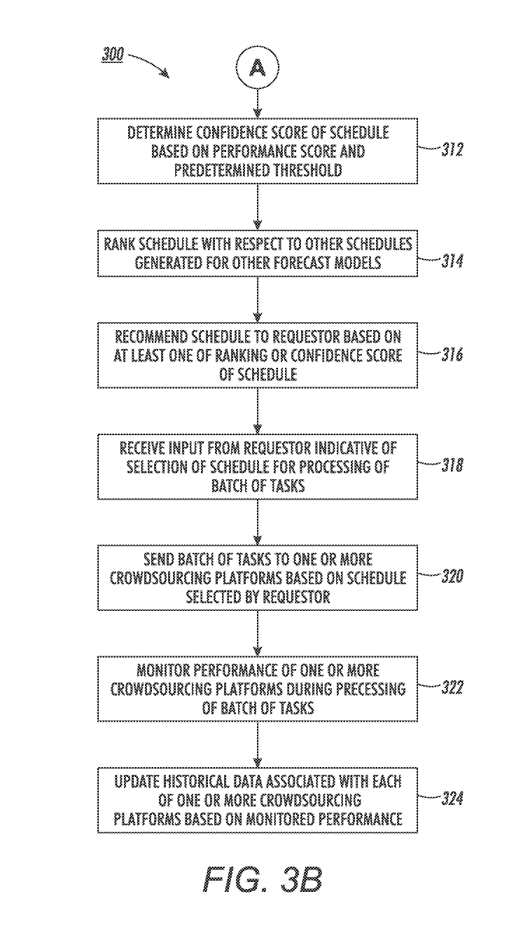

In an embodiment, the application server 106 may receive a batch of tasks, a robustness parameter, and one or more parameters associated with the batch of tasks from the requestor-computing device 108. Further, in an embodiment, the application server 106 may generate one or more forecast models for each of the one or more crowdsourcing platforms from the mathematical model associated with each of the one or more crowdsourcing platforms based on the robustness parameter. In an embodiment, the number of forecast models for a crowdsourcing platform is determined based on the robustness parameter. In addition, in an embodiment, the application server 106 is operable to generate a schedule, based on a forecast model that is associated with each of the one or more crowdsourcing platforms, and the one or more parameters associated with the batch of tasks. The generation of the schedule has been described later conjunction with FIG. 3A and FIG. 3B. Thereafter, in an embodiment, the application server 106 is operable to execute the schedule on each of the one or more forecast models associated with the one or more crowdsourcing platforms to determine a performance score of the schedule on each of the one or more forecast models.

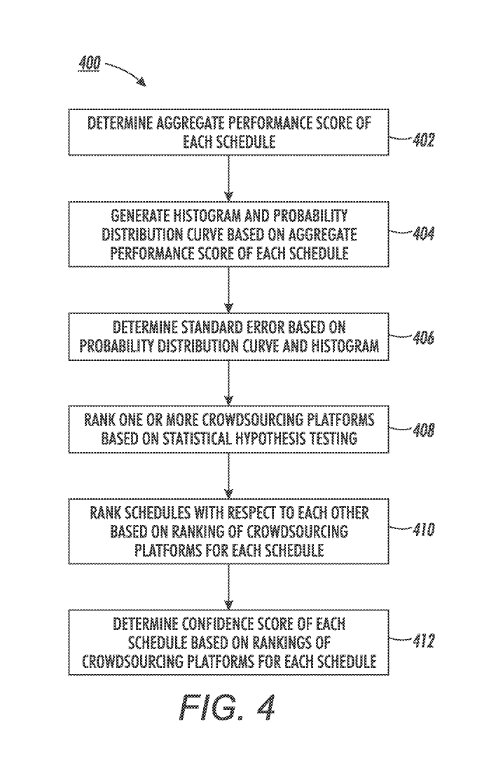

Further, in an embodiment, the application server 106 is operable to recommend the schedule to a requestor based on the performance score. In an embodiment, the application server 106 may determine a confidence score for the schedule. The determination of the performance score and the confidence score has been described later in conjunction with FIG. 3A, FIG. 3B, and FIG. 4. Additionally, in an embodiment, the application server 106 may also rank the schedule with respect to other schedules, which are generated for other forecast models from the one or more forecast models. In an embodiment, the application server 106 may recommend the schedule to the requestor based on at least one of the confidence score or the ranking of the schedule. Post recommending the schedule to the requestor, in an embodiment, the application server 106 may receive an input from the requestor indicative of a selection of the schedule for processing of the batch of tasks. In response to receiving such input from the requestor, in an embodiment, the application server 106 may upload the batch of tasks on the one or more crowdsourcing platforms as per the schedule. As already explained, the crowdsourcing platform server 102 may monitor the performance of the one or more crowdsourcing platforms while the one or more crowdsourcing platform process the batch of tasks. The application server 106 may receive the crowdsourcing platform server 102 for the information pertaining to such monitored performance of the one or more crowdsourcing platforms. Thereafter, the application server 106 may update the historical data (i.e., the one or more mathematical models) associated with each of the one or more crowdsourcing platforms based the information received from the crowdsourcing platform server 102.

Some examples of the application server 106 may include, but are not limited to, a Java application server, a .NET framework, and a Base4 application server.

A person with ordinary skill in the art would understand that the scope of the disclosure is not limited to illustrating the application server 106 as a separate entity. In an embodiment, the functionality of the application server 106 may be implementable on/integrated with the crowdsourcing platform server 102.

In an embodiment, the requestor-computing device 108 is a computing device used by the requestor to send the batch of tasks, the robustness parameter, and the one or more parameters associated with the batch of tasks to the application server 106. Further, in addition, the requestor-computing device 108 may send a request for one or more schedules for processing the batch of tasks. The requestor-computing device 108 may receive a recommendation of the one or more schedules for processing the batch of tasks on the one or more crowdsourcing platforms. Thereafter, the requestor may select a suitable schedule for processing of the batch of tasks on the one or more crowdsourcing platforms. Examples of the requestor-computing device 108 include, but are not limited to, a personal computer, a laptop, a personal digital assistant (PDA), a mobile device, a tablet, or any other computing device.

In an embodiment, the database server 110 is operable to store the historical data associated with each of the one or more crowdsourcing platforms. In addition, the database server 110 may also store the batch of tasks, the robustness parameters, and the one or more parameters associated with the batch of tasks received from the requestor-computing device 108. In an embodiment, the database server 110 may receive a query from the crowdsourcing platform server 102 and/or the application server 106 to extract at least one of the historical data, the batch of tasks, the robustness parameter, or the one or more parameters associated with the batch of tasks from the database server 110. The database server 110 may be realized through various technologies such as, but not limited to, Microsoft® SQL server, Oracle, and My SQL. In an embodiment, the crowdsourcing platform server 102 and/or the application server 106 may connect to the database server 110 using one or more protocols such as, but not limited to, Open Database Connectivity (ODBC) protocol and Java Database Connectivity (JDBC) protocol.

A person with ordinary skill in the art would understand that the scope of the disclosure is not limited to the database server 110 as a separate entity. In an embodiment, the functionalities of the database server 110 can be integrated into the crowdsourcing platform server 102 and/or the application server 106.

In an embodiment, the worker-computing device 112 is a computing device used by a worker. The worker-computing device 112 is operable to present the user interface (received from the crowdsourcing platform) to the worker. The worker receives the one or more tasks from the crowdsourcing platform through the user interface. Thereafter, the worker submits the responses for the tasks through the user interface to the crowdsourcing platform. Examples of the worker-computing device 112 include, but are not limited to, a personal computer, a laptop, a personal digital assistant (PDA), a mobile device, a tablet, or any other computing device.

The network 114 corresponds to a medium through which content and messages flow between various devices of the system environment 100 (e.g., the crowdsourcing platform server 102, the application server 106, the requestor-computing device 108, the database server 110, and the worker-computing device 112). Examples of the network 114 may include, but are not limited to, a Wireless Fidelity (Wi-Fi) network, a Wireless Area Network (WAN), a Local Area Network (LAN), or a Metropolitan Area Network (MAN). Various devices in the system environment 100 can connect to the network 114 in accordance with various wired and wireless communication protocols such as Transmission Control Protocol and Internet Protocol (TCP/IP), User Datagram Protocol (UDP), and 2G, 3G, or 4G communication protocols.

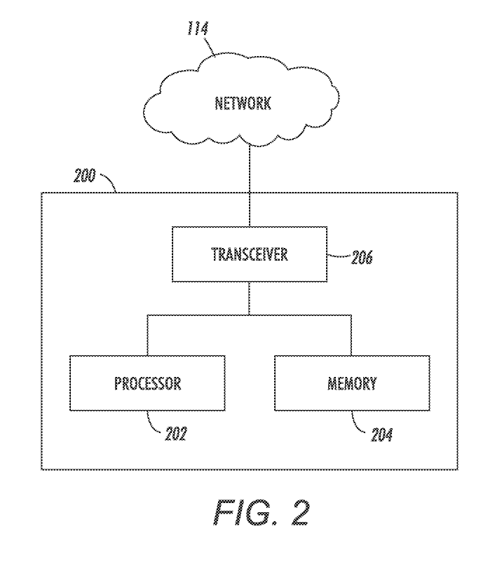

FIG. 2 is a block diagram that illustrates a system 200 for scheduling the batch of tasks on the one or more crowdsourcing platforms, in accordance with at least one embodiment. In an embodiment, the system 200 may correspond to the crowdsourcing platform server 102, the application server 106, or the requestor-computing device 108. For the purpose of ongoing description, the system 200 is considered as the application server 106. However, the scope of the disclosure should not be limited to the system 200 as the application server 106. The system 200 can also be realized as the crowdsourcing platform server 102 or the requestor-computing device 108.

The system 200 includes a processor 202, a memory 204, and a transceiver 206. The processor 202 is coupled to the memory 204 and the transceiver 206. The transceiver 206 is connected to the network 114.

The processor 202 includes suitable logic, circuitry, and/or interfaces that are operable to execute one or more instructions stored in the memory 204 to perform predetermined operations. The processor 202 may be implemented using one or more processor technologies known in the art. Examples of the processor 202 include, but are not limited to, an x86 processor, an ARM processor, a Reduced Instruction Set Computing (RISC) processor, an Application-Specific Integrated Circuit (ASIC) processor, a Complex Instruction Set Computing (CISC) processor, or any other processor.

The memory 204 stores a set of instructions and data. Some of the commonly known memory implementations include, but are not limited to, a random access memory (RAM), a read only memory (ROM), a hard disk drive (HDD), and a secure digital (SD) card. Further, the memory 204 includes the one or more instructions that are executable by the processor 202 to perform specific operations. It is apparent to a person with ordinary skills in the art that the one or more instructions stored in the memory 204 enable the hardware of the system 200 to perform the predetermined operations.

The transceiver 206 transmits and receives messages and data to/from various components of the system environment 100 (e.g., the crowdsourcing platform server 102, the requestor-computing device 108, the database server 110, and the worker-computing device 112) over the network 114. Examples of the transceiver 206 may include, but are not limited to, an antenna, an Ethernet port, a USB port, or any other port that can be configured to receive and transmit data. The transceiver 206 transmits and receives data/messages in accordance with the various communication protocols, such as, TCP/IP, UDP, and 2G, 3G, or 4G communication protocols.

The operation of the system 200 for scheduling the batch of tasks on the one or more crowdsourcing platforms has been described in conjunction with FIG. 3A and FIG. 3B.

FIG. 3A and FIG. 3B together constitute a flowchart 300 illustrating a method for scheduling the batch of tasks on the one or more crowdsourcing platforms, in accordance with at least one embodiment. The flowchart 300 is described in conjunction with FIG. 1 and FIG. 2.

At step 302, the historical data associated with of each of the one or more crowdsourcing platforms is maintained. In an embodiment, the processor 202 is configured to maintain the historical data. In an embodiment, the historical data includes at least the information pertaining to the performance of the one or more crowdsourcing platforms. The processor 202 is further configured to generate a mathematical model for each of the one or more crowdsourcing platforms based on the historical data. Further, in an embodiment, the processor 202 may store the mathematical model in the database server 110. Further, in an embodiment, the processor 202 is operable to receive information pertaining to the performance of the crowdsourcing platform at regular intervals from the crowdsourcing platform server 102. The processor 202 may update the mathematical model based on such received information.

In an embodiment, the information pertaining to the performance of each crowdsourcing platform (hereinafter interchangeably referred as “performance parameters”) may correspond to at least one of a task accuracy, a task completion time, or a task cost. Further, in an embodiment, each mathematical model associated with a crowdsourcing platform may correspond to a weighted linear combination of one or more time series distributions of the performance parameters over the time interval. An example of time series distribution may include a distribution of the task accuracy (in percentage) of workers associated with a crowdsourcing platform in a particular week. A person having ordinary skill in the art would appreciate that each time series distribution may have an associated granularity, for example, “per hour granularity”, i.e., the task accuracy of the workers in each hour through the particular week.

For example, T₁, T₂, T₃, and T₄ are four time series distributions corresponding to the task accuracy of the workers over a particular period, say three months. Each time series distribution (i.e., T₁, T₂, T₃, and T₄) may be generated from the historical data using one or more statistical techniques such as, but not limited to, Auto Regressive Moving Average (ARMA) based modeling, least-square curve fitting algorithm, Bayesian Information Criteria (BIC), or any other statistical technique known in the art. Further, each such time series distribution may have a different granularity. For example, the granularities of the time series distributions T₁, T₂, T₃, and T₄ may be a “sub-hour granularity”, a “per hour granularity”, a “per day granularity”, and a “per week granularity”, respectively. If a time series distribution has the “per-hour granularity”, the data the time series will include data that are sampled on a per hour basis. For example, the time series may include information pertaining to the task accuracy that has been gathered on an hourly basis. Similarly, the “sub hour granularity”, the “per day granularity” and the “per week granularity” correspond to a granularity less than hour basis, a granularity of a distribution at a day level and at a week level, respectively, e.g., the task accuracy of the workers between each day and between each week, respectively.

A mathematical model for the task accuracy of the workers of the crowdsourcing platform over the three month period may be generated as a weighted linear combination of these time series distributions (i.e., T₁, T₂, T₃, and T₄) according to equation 1, as under:

αT₁+βT₂+γT₃+(1−α−β−γ)T₄ (1)

where

α, β, and γ are weights, such that 0≦α, β, γ≦1 and α+β+γ≦1.

A person skilled in the art would understand that the scope of the disclosure should not be limited to the generation of the one or more time series distributions and the mathematical model as described above. The one or more time series distributions and the mathematical model may be generated using any statistical technique known in the art without departing from the spirit of the disclosure. Further, the above examples are for illustrative purposes and should not be used to limit the scope of the disclosure.

At step 304, the batch of tasks, the robustness parameter, and the one or more parameters associated with the batch of tasks are received. In an embodiment, the processor 202 is operable to receive the batch of tasks, the robustness parameter, and the one or more parameters associated with the batch of tasks (hereinafter referred interchangeably as the one or more requirement parameters) from the requestor-computing device 108, through the transceiver 206. Further, the processor 202 may store the received batch of tasks, the robustness parameters, and the one or more requirement parameters in the database server 110. In an embodiment, the one or more requirement parameters comprise at least one of an expected task accuracy, a batch cost, an expected task completion time, or an expected batch completion time.

At step 306, the one or more forecast models are generated for each of the one or more crowdsourcing platforms. In an embodiment, the processor 202 generates the one or more forecast models. In an embodiment, for each crowdsourcing platform, the processor 202 generates the one or more forecast models by varying the mathematical model associated with each crowdsourcing platform based on the robustness parameter. For example, the one or more crowdsourcing platforms include CP₁, CP₂, and CP₃. Each crowdsourcing platform (i.e., CP₁, CP₂, and CP₃) has an associated mathematical model such as M₁, M₂, and M₃ respectively. If the robustness parameter received from the requestor is 3, three forecast models will be generated from each mathematical model. For instance, three forecast models generated from the mathematical model 1 are F1_{M1}, F2_{M1}, and F3_{M1}. Similarly, for the mathematical model M₂, the generated forecast models may include F1_{M2}, F2_{M2}, and F3_{M2}, while for the mathematical model M₃, the generated forecast models may include F1_{M3}, F2_{M3}, and F3_{M3}. Further, each such forecast model may be systematically varied from the respective mathematical model. For instance, each forecast model of type F₁ may correspond to a zero variation from the respective mathematical model. Further, each forecast model of type F₂ and type F₃ may correspond to a 20% variation and a 45% variation respectively, from the respective mathematical model. Therefore, the forecast models F1_{M1}, F1_{M2}, and F1_{M3} are similar to each other as each such forecast model corresponds to a zero variation from the respective mathematical models, i.e., M₁, M₂, and M₃. Similarly, the forecast models F2_{M1}, F2_{M2}, and F2_{M3} correspond to a 20% variation from the respective mathematical models, i.e., M₁, M₂, and M₃, while the forecast models F3_{M1}, F3_{M2}, and F3_{M3} correspond to a 45% variation from the respective mathematical models, i.e., M₁, M₂, and M₃.

In an embodiment, the robustness parameter may be indicative of a degree of variation of the one or more forecast models from the mathematical model associated with the crowdsourcing platform. For example, a value of the robustness parameter provided by the requestor may be an integer from 1 to 5, where 1 corresponds to no variation and 5 corresponds to maximum variation of the one or more forecast models from the mathematical model. If the value of robustness parameter is 1, the processor 202 may generate only one forecast model for each crowdsourcing platform by extrapolating the mathematical model of the crowdsourcing platform. A person skilled in the art would understand that any statistical technique known in the art might be used for such extrapolation of the mathematical model. Further, when the robustness parameter is between 2 to 5, the processor 202 may generate multiple forecast models for each of the one or more crowdsourcing platforms. Each such forecast model may vary from the other forecast models.

In an embodiment, the mathematical model may be varied by varying the one or more weights associated with the one or more time series distributions. For example, referring to equation 1, at least one of the one or more weights (i.e., α, β, and γ) may be varied in order to vary the mathematical model. Alternatively, at least one of the one or more time series distributions (i.e., T₁, T₂, T₃, and T₄) may be varied in order to vary the mathematical model. Additionally, the variation of the mathematical model may be achieved by varying the one or more weights (i.e., α, β, and γ), in addition to varying the one or more time series distributions (i.e., T₁, T₂, T₃, and T₄). For example, if the one or more time series distributions correspond to ARMA models, the one or more time series distributions may be varied by varying weights or noise parameters associated with the corresponding ARMA models.

For example, when a required degree of variation of a mathematical model is 10% and values of the one or more weights in equation 1 are: α=0.2, β=0.3, γ=0.4, and (1−α−β−γ)=0.1. If a is increased by 10% (i.e., the new value of α=0.22), then (1−α−β−γ) decreases by 20% (i.e., the new value of (1−α−β−γ)=0.08). Alternatively, if a is decreased by 10% (i.e., the new value of α=0.18), then (1−α−β−γ) is increases by 20% (i.e., the new value of (1−α−β−γ)=0.12). Thus, an increase or decrease in the value of a by 10% may result in an overall variation of 10%. Therefore, in order to vary the mathematical model by a particular percentage, at least two weights may be selected and then varied in a suitable manner to obtain an overall variation of that particular percentage. Alternatively, at least one time series distribution may be varied directly in a suitable manner to obtain an overall variation of the desired percentage in the overall mathematical model.

A person skilled in the art would understand that scope of the disclosure should not be limited to varying of the mathematical model as described above. The mathematical model may be varied using any statistical technique known in the art without departing from the spirit of the disclosure.

Post generating the one or more forecast models, the processor 202 generates one or more schedules from the one or more forecast models. The generation of the one or more schedules is explained next.

At step 308, a schedule is generated for each forecast model, associated with each of the one or more crowdsourcing platforms. In an embodiment, the processor 202 is operable to generate the schedule. In an embodiment, the processor 202 generates the schedule based on the forecast model and the one or more requirement parameters (i.e., the one or more parameters associated with the batch of tasks). In an embodiment, each schedule is deterministic of the processing of the batch of tasks on the one or more crowdsourcing platforms. For example, the forecast models of type F₁ may include F1_{M1}, F1_{M2}, and F1_{M3}, where M₁, M₂, and M₃ are the mathematical models associated with the crowdsourcing platforms CP₁, CP₂, and CP₃, respectively. In this scenario, the processor 202 may generate a schedule S₁ for the forecast models of type F₁, i.e., the forecast models F1_{M1}, F1_{M2}, and F1_{M3}. Further, in a similar manner, the processor 202 may generate schedules S₂, S₃, and so on for forecast models of type F₂, type F₃ and so on, where the forecast models of type F₂ include F2_{M1}, F2_{M2}, and F2_{M3}, the forecast models of type F₃ include F3_{M1}, F3_{M2}, and F3_{M3}, and so on.

The generation of the schedule for each forecast model, associated with each of the one or more crowdsourcing platforms is now explained through an illustrative example. For the purpose of the example, the one or more crowdsourcing platforms include the crowdsourcing platforms CP₁, CP₂, and CP₃. Further, let M₁, M₂, and M₃ be mathematical models that are associated with the crowdsourcing platforms CP₁, CP₂, and CP₃, respectively. The following table illustrates an example of the mathematical models M₁, M₂, and M₃ modeling a time-series distribution (against time of day) of the task accuracy (in percentage) of the workers associated with the crowdsourcing platforms CP₁, CP₂, and CP₃, respectively.

TABLE 1
An example of the mathematical models M₁, M₂, and M₃ modeling
a timeseries distribution of the task accuracy of the workers associated
with the crowdsourcing platforms CP₁, CP₂, and CP_{3.}

| | Task Accuracy (in %) against Time of Day | | | | | |
|---|---|---|---|---|---|---|
| Mathematical | 9am- | 12pm- | 3pm- | 6pm- | 9pm- | 12am- |
| Model | 12pm | 3pm | 6pm | 9pm | 12am | 3am |
| M₁ (for CP₁) | 85% | 75% | 60% | 90% | 70% | 75% |
| M₂ (for CP₂) | 65% | 70% | 55% | 80% | 60% | 70% |
| M₃ (for CP₃) | 90% | 65% | 80% | 70% | 75% | 85% |

Further, if the value of robustness parameter is 2, two forecast models are generated from each mathematical model. Thus, the forecast models F1_{M1}, F1_{M2}, and F1_{M3} of type F1, and the forecast models F2_{M1}, F2_{M2}, and F2_{M3} of type F2 may be generated from the mathematical models M₁, M₂, and M₃, respectively. It is interesting to note that the forecast models of the type F₁ may be similar to the mathematical models, i.e., the forecast models of the type F₁ may correspond to a zero variation from the mathematical models. Therefore, the forecast models F1_{M1}, F1_{M2}, and F1_{M3} are same as the mathematical models M₁, M₂, and M₃, respectively, as illustrated in Table 1. Further, the forecast models of the type F₂ may correspond to a 20% variation from the mathematical models. The following table illustrates an example of the forecast models that are generated from the mathematical models M₁, M₂, and M₃.

TABLE 2
An example of the forecast models generated from the mathematical
models M₁, M₂, and M₃ when the robustness parameter = 2

| | | Task Accuracy (in %) against Time of Day | | | | | |
|---|---|---|---|---|---|---|---|
| Forecast | | 9am- | 12pm- | 3pm- | 6pm- | 9pm- | 12am- |
| Model | Forecast Model Type | 12pm | 3pm | 6pm | 9pm | 12am | 3am |
| F1_{M1} (for CP₁) | Type F₁ (0% variation | 85% | 75% | 60% | 90% | 70% | 75% |
| F1_{M2} (for CP₂) | from the mathematical | 65% | 70% | 55% | 80% | 60% | 70% |
| F1_{M3} (for CP₃) | models) | 90% | 65% | 80% | 70% | 75% | 85% |
| F2_{M1} (for CP₁) | Type F₂ (20% variation | 68% | 60% | 48% | 72% | 56% | 60% |
| F2_{M2} (for CP₂) | from the mathematical | 78% | 84% | 66% | 96% | 72% | 84% |
| F2_{M3} (for CP₃) | models) | 72% | 52% | 64% | 56% | 60% | 68% |

As is evident from Table 1 and Table 2, the forecast models F1_{M1}, F1_{M2}, and F1_{M3} are same as the mathematical models M₁, M₂, and M₃, respectively. Further, the forecast models F2_{M1} and F2_{M3} correspond to a negative variation of 20% from the mathematical models M₁ and M₃, respectively, while the forecast model F2_{M2} corresponds to a positive variation of 20% from the mathematical model M₂. Based on the forecast models of each type (i.e., the forecast models of the types F₁ and F₂), the processor 202 generates one or more schedules (one schedule for each type of forecast model), for instance the schedules S₁ and S₂. Thus, the schedule S₁ is generated from the forecast models of type F₁ (i.e., F1_{M1}, F1_{M2}, and F1_{M3}), while the schedule S₂ is generated from the forecast models of type F₂ (i.e., F2_{M1}, F2_{M2}, and F2_{M3}). The following table illustrates an example of the schedules S₁ and S₂ for scheduling a batch of 1000 tasks on the crowdsourcing platforms CP₁, CP₂, and CP₃. The one or more requirement parameters in this example may include the expected task accuracy (an average value for the entire batch) of at least 80%.

TABLE 3
An example of schedules S₁ and S₂ for scheduling a batch of
1000 tasks on the crowdsourcing platforms CP₁, CP₂, and CP₃

| | Crowd- | | | | | | | |
|---|---|---|---|---|---|---|---|---|
| | sourc- | No. of tasks against Time of Day | | | | | | |
| Sched- | ing plat- | | 9am- | 12pm- | 3pm- | 6pm- | 9pm- | 12am- |
| ule | form | Total | 12pm | 3pm | 6pm | 9pm | 12am | 3am |
| S₁ | CP₁ | 435 | 130 | 80 | — | 150 | — | 75 |
| | CP₂ | 105 | — | — | — | 105 | — | — |
| | CP₃ | 460 | 150 | — | 105 | — | 80 | 125 |
| S₂ | CP₁ | 160 | 60 | — | — | 100 | — | — |
| | CP₂ | 700 | 130 | 150 | — | 180 | 100 | 140 |
| | CP₃ | 140 | 100 | — | — | — | — | 40 |

As illustrated in Table 3, schedule S₁ distributes a total of 435, 105, and 460 tasks from the batch of 1000 tasks to the crowdsourcing platforms CP₁, CP₂, and CP₃, respectively, during the day (i.e., from 9 am of a Day1 to 3 am of a Day2). Further, the schedule S₂ distributes a total of 160, 700, and 140 tasks to the crowdsourcing platforms CP₁, CP₂, and CP₃, respectively, during the day. A person skilled in the art would appreciate that the overall task accuracy of a schedule for the entire batch of tasks may be determined as a weighted average of the task distribution of the schedule. Further, the weight assigned to each set of tasks distributed to a crowdsourcing platform during a time of day may be based on the task accuracy of the crowdsourcing platform during that time of day, as determined from a relevant forecast model associated with the crowdsourcing platform and the schedule. For instance, for the schedule S₁, the weight assigned to the set of 130 tasks distributed to crowdsourcing platform CP₁ between gam-12 pm may be 0.85, since the task accuracy of the crowdsourcing platform CP1 is 85% during gam-12 pm, as per the forecast model F1_{M1} (refer Table 2).

Thus, to determine the overall task accuracy of the schedules S₁ and S₂, the schedules S₁ and S₂ are executed on each forecast model of the types F₁ and F₂ respectively. Accordingly, the overall task accuracy of the schedules S₁ and S₂ are 84% (i.e., (0.85*130+0.9*150+0.75*80+0.8*105+0.9*150+0.8*105+0.75*80+0.75*75+0.85*125)/1000) and 80.18% (i.e., (0.68*160+0.78*130+0.72*100+0.84*150+0.72*100+0.96*180+0.72*100+0.84*140+0.68*40)/1000), respectively. As is evident, the overall task accuracy for each of the schedules S₁ and S₂ (i.e., 84% and 80.18%, respectively) is above the expected task accuracy (i.e., 80%).

A person skilled in the art would understand that the scope of the disclosure should not be limited to the schedule, as illustrated above. The above mentioned examples are for illustrative purposes and should not be used to limit the scope of the disclosure.

In an embodiment, the schedule is generated using a Bayesian Optimization technique. To generate the schedule for each forecast model, associated with each of the one or more crowdsourcing platforms, the processor 202 may generate an objective function to be iteratively optimized using Bayesian Optimization. In an embodiment, the objective function may correspond to a random function of one or more adjustable parameters associated with the batch of tasks (which are modifiable during each iteration of the scheduling). In an embodiment, the one or more adjustable parameters may include parameters such as, but not limited to, a set crowdsourcing platforms selected from the one or more crowdsourcing platforms, a batch size, a time of day, a day of week, a remuneration per task, a number of validations per task, etc.

The objective function may be modeled using a Gaussian Process. Further, in an embodiment, the objective function for a given schedule (e.g., schedule S₁) may be based on each forecast model associated with the one or more crowdsourcing platforms (for e.g. the forecast models of type F₁ including F1_{M1}, F1_{M2}, and F1_{M3}) from which the given schedule is to be generated.

In each iteration of the optimization process, the processor 202 may sample optimum values of the one or more adjustable parameters using a sampling rule. The goal of Bayesian Optimization is:

“Maximization of a sum of rewards Σ₁^{T}f(xₜ) in T iterations, such that x*=argmax_{xεD}f(x) is achieved in a minimum number of iterations” (2)

where

‘f’ is the objective function, x is a vector of the one or more adjustable parameters,

‘D’ is the domain of the one or more adjustable parameters,

xₜ is the vector of the one or more parameters sampled at iteration ‘t’, and

x* is an optimum vector of the one or more adjustable parameters obtained after ‘T’ iterations.

To sample optimum values of the one or more adjustable parameters from the domain ‘D’, in an embodiment, the processor 202 may use an “Upper Confidence Bound (UCB) as per the following equation:

$${x}_{t} = {argmax}_{x ∈ D} {μ}_{t - 1} ( x ) + {β}_{t}^{\frac{1}{2}} {σ}_{t - 1} ( x ) \qquad ( 3 )$$

where

xₜ is a vector of the one or more adjustable parameters chosen at the iteration ‘t’,

σₜ₋₁ and μₜ₋₁ are the covariance function and the mean function of the Gaussian Process at the end of iteration ‘t−1’, and

βₜ is a constant. (For the first iteration, i.e., when t=1, σ₀ and μ₀ are the initial covariance function and the initial mean function of the Gaussian Process, respectively.)

As is evident from equation 3, the sampled values include values from known regions of the Gaussian Process that have high mean (which includes values closer to maxima) and values from unknown regions of the Gaussian Process that have high variance. Thus, the above sampling technique would enhance optimizing and learning of the unknown (random) function ‘f’ simultaneously.

A person skilled in the art would understand that the scope of the disclosure should not be limited to using the UCB rule for sampling. Other sampling rules known in the art may be used for sampling without departing from the spirit of the disclosure.

Further, at each iteration ‘t’, the processor 202 may determine a vector of one or more response parameters (i.e., an expected performance of the one or more crowdsourcing platforms) as an observed value of the objective function ‘f’ at the iteration ‘t’, i.e., yₜ=f (xₜ)+θ, where θ corresponds to noise. As the value of objective function determined at iteration ‘t’ is used for further optimization of the objective function (refer to the goal of optimization, as mentioned in condition 2), the one or more response parameters determined at iteration ‘t’ are used for the optimum sampling of the one or more adjustable parameters at iterations ‘t+1’, and so on. Further, in an embodiment, the schedule corresponds to the vectors of the one or more adjustable parameters obtained at the end of ‘T’ iterations of the process. Thus, the schedule includes a total of ‘T’ vectors of the one or more adjustable parameters, each of which is obtained in an iteration t of the optimization process, where 1≦t≦T.

A person skilled in the art would understand that the scope of the disclosure should not be limited to using Bayesian optimization for generation of the schedule. In an embodiment, the schedule may be generated using one or more other optimization techniques such as, but not limited to, an exploration/exploitation based optimization, a multi-armed bandits based optimization, Naïve Bayes Classifiers based optimization, fuzzy logic, neural networks, genetic algorithm, Support Vector Machines (SVM), regression based optimization, or any other optimization technique known in the art.

Post the generation of the schedule, the schedule is executed on each of the one or more forecast models associated with each of the one or more crowdsourcing platforms, as explained next.

At step 310, the schedule is executed on each of the one or more forecast models associated with each of the one or more crowdsourcing platforms. In an embodiment, the processor 202 is operable to execute the schedule on each of the one or more forecast models associated with the one or more crowdsourcing platforms. Further, in an embodiment, the processor 202 is operable to determine the performance score of the schedule on the one or more forecast models. Referring to the example of schedules S₁ illustrated in Table 3, the processor 202 determines the performance score of the schedule S₁ on each forecast model of type F₁ (including F1_{M1}, F1_{M2}, and F1_{M3}) and type F₂ (including F2_{M1}, F2_{M2}, and F2_{M3}). Accordingly, the performance score of the schedule S₁ (in terms of task accuracy in percentage) on the forecast model F1_{M1} (denoted as P(S₁,F1_{M1})) may be determined as 0.83 (i.e., (0.85*130+0.75*80+0.9*150+0.75*75)/435). Further, the performance score of the schedule S₁ on the forecast models F1_{M2} and F1_{M3} (denoted as P(S₁,F1_{M2}) and P(S₁,F1_{M3}), respectively) may be determined as 0.80 (i.e., (0.8*105)/105) and 0.84 (i.e., (0.9*150+0.8*105+0.75*80+0.85*125)/460), respectively. Similarly, the processor 202 may determine the performance scores of the schedule S₁ on the forecast models F2_{M1}, F2_{M2}, and F2_{M3} (denoted as P(S₁,F2_{M2}), P(S₁,F2_{M2}), and P(S₁,F2_{M3}) respectively) as 0.665, 0.96, and 0.67, respectively.

Further, in an embodiment the processor 202 may determine an aggregate performance score of the schedule based on an aggregation of the performance scores of the schedule on each forecast model. To that end, the processor 202 may first determine the performance score of the schedule on each forecast model of a particular type (e.g., F₁ and F₂) to determine performance scores of the schedule on the particular type of forecast models (denoted as P(S₁, F₁) and P(S₁, F₂), respectively). Thereafter, the processor 202 may aggregates the determined performance scores of the schedule on the different types of forecast models (such as P(S₁, F₁) and P(S₁, F₂)) to determine the aggregate performance score of the schedule (denoted as P(S₁)). In an embodiment, the aggregation may be performed using one or more techniques such as, but not limited to, mean, weighted mean, summation, weighted summation, median, or any other aggregation technique.

For instance, the performance score of the schedule S₁ on the forecast models of type F₁ (i.e. P(S₁,F₁)) may be determined as 0.84 (i.e., (435*0.83+105*0.80+460*0.84)/1000). Similarly, the performance score of the schedule S₁ on the forecast models of type F₂ (i.e. P(S₁,F₂)) may be determined as 0.699 (i.e., (435*0.665+105*0.96+460*0.67)/1000). Further, the aggregate performance score of the schedule S₁ (i.e., P(S₁)) may be determined as (W₁*P(S₁,F₁)+W₂*P(S₁,F₂))/(W₁+W₂), where W₁ and W₂ are weights assigned to the forecast models of types F₁ and F₂, respectively. If W₁=0.75 and W₂=0.25, P(S₁) may be determined as 0.805.

In an embodiment, the performance scores of a schedule on each of the one or more forecast models may be weighted before aggregation based on the performance parameters (which have been discussed in step 302) associated with each of the one or more crowdsourcing platforms. For example, the task accuracy (in percentage) of workers associated with a crowdsourcing platform (say CP₁) shows low variance in the recent past (say last 2 weeks). In this scenario, during the aggregation, the performance score of the schedule on the forecast models (associated with the crowdsourcing platform) having higher variance from the historical data (i.e., F2_{M1}) may be assigned a lower weight than the performance score of the schedule on the forecast models (associated with the crowdsourcing platform) having lower variance from the historical data (i.e., F1_{M1}).

In an embodiment, the processor 202 may reject the schedule if the aggregate performance score of the schedule does not satisfy the one or more requirement parameters. For example, if the expected task accuracy (which is included in the one or more requirement parameters) is given as 82%, the schedule S₁ of the above example may be rejected as the value of the aggregate performance score of schedule S₁, i.e., P(S₁) is 80.5% (i.e. 0.805).

At step 312, the confidence score of the schedule is determined based on the performance score and a predetermined threshold. In an embodiment, the processor 202 is operable to determine the confidence score of the schedule. In an embodiment, the confidence score of the schedule may be determined as a fraction of the one or more forecast models on which the performance score of the schedule exceeds the predetermined threshold.

For example, the performance scores of a schedule S₁ on forecast models of types F₁, F₂, and F₃ i.e., P(S₁,F₁), P(S₁,F₂), P(S₁,F₃), respectively, are determined as 0.705, 0.84, and 0.71, respectively. If the predetermined threshold is 0.80, the confidence score of the schedule S₁ may determined as ⅓ (i.e., 0.33), as the performance scores of the schedule S₁ exceed the predetermined threshold (i.e., 0.80) on 1 out of 3 forecast model types (i.e., forecast models of type F₂).

At step 314, the schedule is ranked with respect to other schedules that are generated for other forecast models. In an embodiment, the processor 202 is operable to rank the schedule. In an embodiment, the processor 202 ranks the schedule with respect to the other schedules based on an aggregation of the performance scores of the schedule on each of the one or more forecast models. Thus, in an embodiment, the processor 202 ranks the schedules based on the aggregate performance scores of the schedules, For example, the processor 202 ranks the schedules S₁ and S₂ based on the aggregate performance scores of S₁ and S₂, i.e., P(S₁) and P(S₂), respectively.

An alternate embodiment of the determination of the confidence score of the schedule (step 312) and the ranking of the schedule with respect to the other schedules (step 314) has been described later with reference to FIG. 4.

A person skilled in the art would understand that the scope of the disclosure should not be limited to the determining of the confidence score of the schedule and the ranking of the schedule with respect to the other schedules as illustrated above. The confidence score of the schedule may be determined using any statistical technique known in the art. Further, the schedule may be ranked with respect to the other schedules using any suitable technique.

At step 316, the schedule is recommended to the requestor based on at least one of the ranking or the confidence score of the schedule. In an embodiment, the processor 202 is operable to recommend the schedule to the requestor on the requestor-computing device 108. In an embodiment, the requestor may be displayed a sorted list of the one or more schedules with the corresponding ranks and confidence scores of each schedule. In addition, in an embodiment, the requestor may also be displayed the maximum and the minimum performance scores corresponding to each schedule. Using these recommendations, the requestor may provide an input indicative of a selection of one of the one or more recommended schedules for processing of the batch of tasks.

At step 318, the input indicative of the selection of a schedule from the one or more recommended schedules is received from the requestor. In an embodiment, the processor 202 is operable to receive this input from the requestor through the requestor-computing device 108, via the transceiver 206. Based on the received input from the requestor, the tasks within the batch of tasks are scheduled for execution on the one or more crowdsourcing platforms.

At step 320, the batch of tasks is sent to the one or more crowdsourcing platforms based on the schedule selected by the requestor. In an embodiment, the processor 202 is operable to extract the batch of tasks from the database server 110. Thereafter, in an embodiment, based on the schedule selected by the requestor, the processor 202 sends the batch of tasks to the one or more crowdsourcing platforms through the transceiver 206. The following table illustrates an example of a schedule selected by the requestor for processing of a batch of tasks containing 50,000 tasks on 3 crowdsourcing platforms during an interval of 4 weeks.

TABLE 4
An example schedule for processing 50,000 tasks on 3
crowdsourcing platforms during an interval of 4 weeks

| Time slot | Crowdsourcing platform | Tasks |
|---|---|---|
| TS₁: Week 1 | Amazon Mechanical Turk | Tasks 1- 20,000 |
| | Mobile Works | Tasks 20,001-25,000 |
| TS₂: Week 2 | Crowd Flower | Tasks 25,001-30,000 |
| TS₃: Week 3 | Mobile Works | Tasks 30,001-38,000 |
| TS₄: Week 4 | Amazon Mechanical Turk | Tasks 38,001-45,000 |
| | Crowd Flower | Tasks 45,001-50,000 |

Referring to Table 4 above, the batch of tasks containing 50,000 tasks is scheduled for processing on 3 crowdsourcing platforms (i.e., Amazon Mechanical Turk (AMT), Mobile Works (MW), and Crowd Flower (CF)) during an interval of 4 weeks. The scheduling interval of 4 weeks is divided in four time slots (i.e., TS₁, TS₂, TS₃, and TS₄) of one week each. As is evident from Table 4, tasks 1-20,000 are sent to AMT and tasks 20,001-25,000 are sent to MW in the first time slot, i.e., TS₁ (during the first week). Further, tasks 25,001-30,000 are sent to CF and tasks 30,001-38,000 are sent to MW during the time slots TS₂ (second week) and TS₃ (third week), respectively. Finally, during the fourth week corresponding to the time slot TS₄, tasks 38,001-45,000 are sent to AMT and tasks 45,001-50,000 are sent to CF.

A person skilled in the art would understand that the above example of schedule is an illustrative example. The scope of the disclosure should not be limited to such illustrative examples. The schedule of the disclosure may be implemented in any manner without departing from the spirit of the disclosure.

At step 322, the performance of the one or more crowdsourcing platforms is monitored during the processing of the batch of tasks. In an embodiment, the processor 202 is operable to determine the performance of the one or more crowdsourcing platforms during the processing of the batch of tasks. To that end, the processor 202 may send a request to the crowdsourcing platform server 102 for information pertaining to the performance (i.e., the performance parameters) of the one or more crowdsourcing platforms during the processing of the one or more tasks on the one or more crowdsourcing platforms. In an embodiment, the processor 202 may send such requests periodically, at a gap of a predetermined time interval, to determine the performance of the one or more crowdsourcing platforms during the time elapsed in the preceding time interval. Thereafter, in response to such requests, the processor 202 may receive the value of the performance parameters (corresponding to the relevant time interval) associated with the one or more crowdsourcing platforms from the crowdsourcing platform server 102. Further, the processor 202 may update the historical data associated with the one or more crowdsourcing platforms based on the received performance parameters corresponding to the relevant time interval.

At step 324, the historical data associated with each of the one or more crowdsourcing platforms is updated. In an embodiment, the processor 202 is operable to update the historical data by updating the mathematical model associated with each of the one or more crowdsourcing platforms based on the monitored performance of the one or more crowdsourcing platforms. Thereafter, the processor 202 stores the updated historical data (i.e., the updated mathematical model) in the database server 110.

Thus, the mathematical model associated with a crowdsourcing platform is updated periodically, at a gap of the predetermined time interval, based on the observed performance (i.e., the received performance parameters) of the crowdsourcing platform during the time elapsed in the preceding time interval. This ensures that the historical data (i.e., the mathematical model) remains up-to-date.

FIG. 4 is a flowchart 400 that illustrates a method for ranking a schedule with respect to other schedules and determining a confidence score of the schedule, in accordance with at least one embodiment.

At step 402, the aggregate performance score of each of the one or more schedules is determined. In an embodiment, the processor 202 determines the performance scores of each schedule on each forecast model associated with the one or more crowdsourcing platforms by executing the schedule on each such forecast model, as discussed in step 310. Thereafter, the processor 202 determines the aggregate performance score of each schedule based on an aggregation of the performance scores of the schedule. For example, for schedules S₁ and S₂, the processor 202 determines the aggregate performance scores P(S₁) and P(S₂).

At step 404, a histogram and a probability distribution curve is generated based on the aggregate performance scores of each schedule. In an embodiment, the processor 202 generates the histogram and the probability distribution curve based on the aggregate performance score of each schedule.

At step 406, a standard error is determined based on the probability distribution curve and the histogram. In an embodiment, the processor 202 determines the standard error based on the probability distribution curve. For example, the processor 202 may determine the standard error from mean (SEM) from the probability distribution curve of the aggregate performance scores of each schedule for the one or more crowdsourcing platforms using the following equation:

$$S E M = \frac{s}{\sqrt{n}} \qquad ( 4 )$$

where

‘s’ is the standard deviation of the probability distribution curve from the aggregate performance score of each schedule, and

‘n’ is the number of samples in the probability distribution curve.

At step 408, the one or more crowdsourcing platforms are ranked with respect to each other based on statistical hypothesis testing. In an embodiment, the processor 202 is operable to rank the one or more crowdsourcing platforms for each forecast model type based on a statistical hypothesis testing technique and the determined standard error. To rank the one or more crowdsourcing platforms, in an embodiment, the processor 202 may compare the individual performance scores of each schedule on each forecast model of a particular type based on the determined standard error.

Post the comparison of the performance scores on each forecast model of the particular type, the processor 202 may rank the one or more crowdsourcing platforms with respect to each other by performing a statistical hypothesis testing. The null hypothesis and the alternative hypothesis used for such statistical hypothesis testing are as under:

Null Hypothesis: “Performance scores for each of the one or more crowdsourcing platforms are same.”
Alternative Hypothesis: “Performance score for a first crowdsourcing platform is better than performance score of a second crowdsourcing platform.”
Based on the comparisons between the performance scores of each schedule for the one or more crowdsourcing platforms, the processor 202 determines an outcome of the above statistical hypothesis test. Thereafter, for the particular type of forecast model, in an embodiment, the processor 202 determines an aggregate rank for each of the one or more crowdsourcing platforms based on the outcome of the above statistical hypothesis test.

For example, schedules S₁ and S₂ are executed on the forecast models of type F₁ (including F1_{M1}, F1_{M2}, and F1_{M3}). Thereafter, the performance scores of the schedule S₁ for the crowdsourcing platforms CP₁, CP₂, and CP₃ i.e., P(S₁, F1_{M1}), P(S₁, F1_{M2}), and P(S₁, F1_{M3}) are determined as 0.83, 0.80, and 0.84, respectively. Further, the performance scores of the schedule S₂ for the crowdsourcing platforms CP₁, CP₂, and CP₃ i.e., P(S₂, F1_{M1}), P(S₂, F1_{M2}), and P(S₂, F1_{M3}) are determined as 0.705, 0.84, and 0.71, respectively. The crowdsourcing platforms are ranked based on the performance scores for the crowdsourcing platforms on the individual schedules. Thus, the ranking of the crowdsourcing platforms (i.e., CP₁, CP₂, and CP₃) are {2, 3, 1} for schedule S₁, and {3, 1, 2} for schedule S₂, respectively. The aggregate ranking of the crowdsourcing platforms for the forecast models of the type F₁ may be determined as an average ranking of the crowdsourcing platforms on the individual schedules, i.e., {2.5, 2, 1.5} for the crowdsourcing platforms CP₁, CP₂, and CP₃, respectively.

Further, in an embodiment, the processor 202 may determine the rank of each schedule for the given forecast model type, based on the aggregate rank assigned (using the statistical hypothesis test) to the crowdsourcing platform, which has a maximum performance score for the schedule. Referring to the above example, the crowdsourcing platform CP₃ has the maximum performance score for the schedule S₁, i.e., 0.84. Further, the aggregate rank of the crowdsourcing platform CP₃ for the forecast models of type F₁ is 1.5. Hence, for the forecast models of type F₁, the processor 202 may assign the rank 1.5 to the schedule S₁.

A person skilled in the art would understand that the scope of the disclosure should not be limited to the ranking of the one or more crowdsourcing platforms using statistical hypothesis testing, as discussed above. Any statistical technique known in the art may be used to rank the one or more crowdsourcing platforms without departing from the spirit of the disclosure.

Post ranking the one or more crowdsourcing platforms for each schedule on the forecast models of a given type, step 408 is repeated for the other types of forecast models, i.e., the forecast models other than the given forecast model type. Thereafter, the processor 202 may collate the ranking of the one or more crowdsourcing platforms for each forecast model type. For example, the processor 202 may generate a N×K matrix to collate such ranking, where N is the number of schedules, K is the number of forecast model types, and each entry in this matrix may represent the rank of a schedule for a forecast model type. The following table illustrates an example of the N×K matrix with N=3 and K=3.

TABLE 5
An example of N × K matrix (with N = 3 and K =
3) of ranks of schedules for forecast model types

| | F₁ | F₂ | F₃ |
|---|---|---|---|
| S₁ | R(S₁, F₁) | R(S₁, F₂) | R(S₁, F₃) |
| S₂ | R(S₂, F₁) | R(S₂, F₂) | R(S₂, F₃) |
| S₃ | R(S₃, F₁) | R(S₃, F₂) | R(S₃, F₃) |

Referring to Table 5, row 1 of the 3×3 matrix holds the ranks of the schedule S₁ for the forecast models of types F₁, F₂ and F₃ (such as R(S₁,F₁), R(S₁,F₂), and R(S₁,F₃), respectively). Further, rows 2 and 3 of the above 3×3 matrix hold the ranks of schedules S₂ (such as R(S₂,F₁), R(S₂,F₂), and R(S₂,F₃)) and S₃ (such as R(S₃,F₁), R(S₃,F₂), and R(S₃,F₃)) for the forecast models of the types F₁, F₂ and F₃.

At step 410, the one or more schedules are ranked with respect to each other. In an embodiment, the processor 202 is operable to rank the one or more schedules with respect to each other based on the ranking of the one or more crowdsourcing platforms for the schedules on each forecast model type. For example, the processor 202 may utilize the N×K matrix to rank the one or more schedules with respect to each other. In an embodiment, the processor 202 may take a majority consensus of the ranks of each schedule on each forecast model type. For example, if the ranks of a schedule S₁ on forecast models types F₁, F₂, and F₃ are 1.5, 2, and 1.5, respectively, the majority consensus rank of the schedule S₁ is 1.5. Such majority consensus rank may be determined for the other schedules as well, and the one or more schedules may be ranked with respect to each other based on such majority consensus ranks.

At step 412, the confidence score of each schedule is determined. In an embodiment, the processor 202 is configured to determine the confidence score of each schedule based on ranking of one or more crowdsourcing platforms for the schedules on each forecast model type. In an embodiment, to determine the confidence score of a schedule, the processor 202 may compare the ranks, which are assigned to the one or more crowdsourcing platforms for each of the one or more schedules. In an embodiment, the processor 202 may determine the confidence score of the schedule based on a fraction of other schedules on which each crowdsourcing platform is assigned an equal or a higher rank. For example, the ranks assigned to crowdsourcing platforms CP₁, CP₂, and CP₃ for schedules S₁, S₂, S₃, and S₄ are {3,2,1}, {1,3,2}, {3,1,2}, and {1,2,1}, respectively. In this scenario, the processor 202 may determine the confidence score of the schedule S₁ for the crowdsourcing platform CP₁ as 1, since an equal or a higher rank is assigned to CP₁ for all the other schedules, i.e., S₂, S₃, and S₄. Further, the confidence score of the schedule S₁ for the crowdsourcing platforms CP₂ and CP₃ may be determined as 0.67 and 0.33, respectively, since an equal or a higher rank is assigned to CP₂ and CP₃ for 2 (i.e., S₃ and S₄) out of 3 other schedules and 1 (i.e., S₄) out of 3 other schedules, respectively.

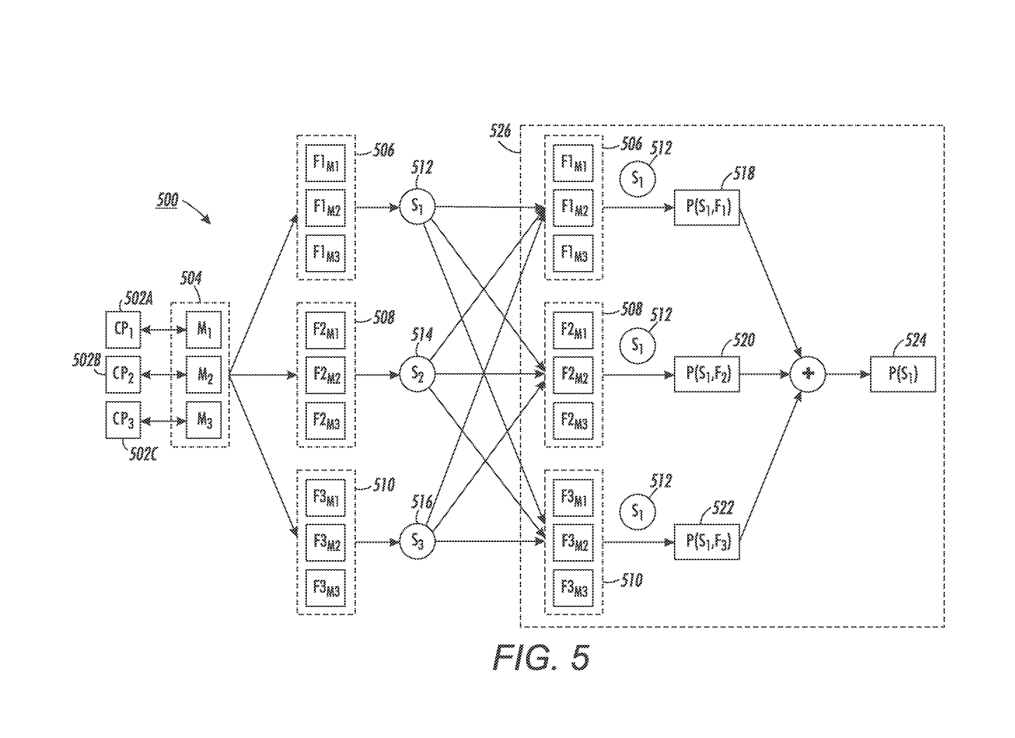

FIG. 5 is a process flow diagram 500 that illustrates a method for scheduling the batch of tasks on the one or more crowdsourcing platforms, in accordance with at least one embodiment.

As illustrated in the process flow diagram 500, the one or more crowdsourcing platforms include crowdsourcing platforms CP₁, CP₂, and CP₃ (denoted by 502a, 502b, and 502c, respectively). Further, a mathematical model M₁ models performance of the crowdsourcing platform CP₁ based on historical data associated with the crowdsourcing platform CP₁. Similarly, mathematical models M₂ and M₃ model performance of the crowdsourcing platforms CP₂ and CP₃, respectively. The mathematical models M₁, M₂, and M₃ are collectively denoted as 504. The generation of the mathematical models from the historical data has been explained in conjunction with FIG. 3A (step 302).

Assuming a robustness parameter of 3, three types of forecast models (such as 506, 508, and 510) may be generated from each of the mathematical model (M₁, M₂, and M₃) by systematically varying each mathematical by 0%, 20% and 45% respectively. Accordingly, forecast models F1_{M1}, F1_{M2}, and F1_{M3} (collectively donated as 506) are generated from the mathematical models 504 without varying the mathematical models 504. Thus, the forecast models F1_{M1}, F1_{M2}, and F1_{M3} are same as the mathematical models M₁, M₂, and M₃, respectively. Further, forecast models F2_{M1}, F2_{M2}, and F2_{M3} (collectively donated as 508) are generated based on a 20% variation of the mathematical models 504 (i.e., the forecast model F2M₁ corresponds to a 20% variation of the mathematical model M₁, and so on), while forecast models F3_{M1}, F3_{M2}, and F3_{M3} (collectively denoted as 510) are generated based on a 45% variation of the mathematical models 504 (i.e., the forecast model F3M₁ corresponds to a 45% variation of the mathematical model M₁, and so on). The generation of the forecast models has been explained in conjunction with FIG. 3a (step 306).

Post generation of the forecast models 506, 508, and 510, schedules S₁ (denoted by 512), S₂ (denoted by 514), and S₃ (denoted by 516) are generated from the forecast models 506, 508, and 510, respectively. Thereafter, each such generated schedule (i.e., S₁, S₂, and S₃) is executed on the forecast models of each type, i.e., 506, 508, and 510. The generation of the schedules and the execution of schedules on the forecast models have been explained in conjunction with FIG. 3A (steps 308 and 310, respectively).

An illustration of the execution of the schedule S₁ (denoted by 512) on the forecast models of each type, i.e., 506, 508, and 510 is depicted by 526. The other schedules, i.e., the schedules S₂ and S₃ (denoted by 514 and 516, respectively) are executed on the forecast models of each type, i.e., 506, 508, and 510, in a manner similar to that depicted by 526. Accordingly, the connections of schedule S₁ with the forecast models 506, 508, and 510 are depicted with bold lines, while the connections of the schedules S₂ and S₃ with the forecast models 506, 508, and 510 are depicted with dotted lines. The execution of the schedule S₁ on the forecast models 506, 508, and 510, as depicted by 526, is explained next.

As depicted by 526, the schedule S₁ is executed on the forecast models F1_{M1}, F1_{M2}, and F1_{M3} (i.e., the forecast models of type 506) to determine performance score of the schedule S₁ on the forecast models of type 506, i.e., P(S₁,F₁) (denoted by 518). Similarly, the schedule S₁ is executed on the forecast models of type 508 (i.e., the forecast models F2_{M1}, F2_{M2}, and F2_{M3}) and the forecast models of type 510 (i.e., the forecast models F3_{M1}, F3_{M2}, and F3_{M3}) to determine performance scores P(S₁,F₂) and P(S₁,F₃), respectively, which are denoted as 520 and 522, respectively. Further, the performance scores P(S₁,F₁), P(S₁,F₂) and P(S₁,F₃) (denoted by 518, 520, and 522) are aggregated to determine aggregated performance score P(S₁), which is denoted by 524. The aggregate performance scores of the schedules S₂ and S₃ (such as P(S₂) and P(5₃)) may be determined is a manner similar to that depicted by 526 with respect to the schedule S₁. The determination of the performance scores of the schedule on the forecast models of each type and the aggregation of such performance scores to determine the aggregate performance score of the schedule has been explained with reference to FIG. 3A (step 310).

Further, a confidence score may be determined for each schedule S₁, S₂, and S₃. Thereafter, the schedules S₁, S₂, and S₃ may be ranked with respect to each other. The determination of the confidence score of the schedules and the ranking of the schedules have been explained with reference to FIG. 3B (steps 312 and 314, respectively) and FIG. 4. In an embodiment, the schedules S₁, S₂, and S₃ may be recommended to a requestor based on at least one of the aggregate performance score, the confidence score, or the ranking of each schedule.

The disclosed embodiments encompass numerous advantages. Various embodiments of the disclosure lead to efficient scheduling of large batches of tasks on multiple crowdsourcing platforms over an extended period of time. The performance of each of the one or more crowdsourcing platforms is predicted based on the one or more forecast models, generated for each of the one or more crowdsourcing platforms. An advantage of the disclosure lies in the robustness of such predictions to erratic variations in the real-performance of the one or more crowdsourcing platforms over the extended period of time. As described with reference to FIG. 3A and FIG. 3B, the mathematical model associated with the crowdsourcing platforms is systematically varied based on the robustness parameters to generate the one or more forecast models. Such systematic variation of the one or more forecast models ensures robustness of the predictions made using such forecast models. Further, the one or more schedules are generated based on the one or more forecast models. Thus, as such, the one or more schedules are at least as robust as the one or more forecast models.

The one or more schedules are ranked and assigned confidence scores. The requestor is recommended the one or more schedules and provided with the ranking and the confidence scores associated with the each of the one or more schedules. As the requestor is provided a basis to accept or reject a recommended schedule, the requestor can make an informed decision about scheduling of the batch of tasks. Further, the performance of the one or more crowdsourcing platforms is monitored when the batch of tasks is processed on the one or more crowdsourcing platforms based on a user-selected selected schedule. Such monitoring helps to keep the historical data up-to-date.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit, and the internet. The computer further comprises a microprocessor. The microprocessor is connected to a communication bus. The computer also includes a memory. The memory may be RAM or ROM. The computer system further comprises a storage device, which may be a HDD or a removable storage drive such as a floppy-disk drive, an optical-disk drive, and the like. The storage device may also be a means for loading computer programs or other instructions onto the computer system. The computer system also includes a communication unit. The communication unit allows the computer to connect to other databases and the internet through an input/output (I/O) interface, allowing the transfer as well as reception of data from other sources. The communication unit may include a modem, an Ethernet card, or other similar devices that enable the computer system to connect to databases and networks, such as, LAN, MAN, WAN, and the internet. The computer system facilitates input from a user through input devices accessible to the system through the I/O interface.

To process input data, the computer system executes a set of instructions stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or only hardware, or using a varying combination of the two techniques. The disclosure is independent of the programming language and the operating system used in the computers. The instructions for the disclosure can be written in all programming languages, including, but not limited to, ‘C’, ‘C++’, ‘Visual C++’ and ‘Visual Basic’. Further, software may be in the form of a collection of separate programs, a program module containing a larger program, or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms, including, but not limited to, ‘Unix’, DOS′, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the methods and systems for scheduling a batch of tasks have been disclosed. However, it should be apparent to those skilled in the art that modifications in addition to those described are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or used, or combined with other elements, components, or steps that are not expressly referenced.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like.

The claims can encompass embodiments for hardware and software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A method for scheduling a batch of tasks on one or more crowdsourcing platforms, the method comprising:
generating, by one or more processors, one or more forecast models for each of the one or more crowdsourcing platforms based on historical data associated with each of the one or more crowdsourcing platforms and a robustness parameter;
for a forecast model, from the one or more forecast models, associated with each of the one or more crowdsourcing platforms:
generating, by the one or more processors, a schedule based on the forecast model and one or more parameters associated with the batch of tasks, wherein the schedule is deterministic of the processing of the batch of tasks on the one or more crowdsourcing platforms;
executing, by the one or more processors, the schedule on each of the one or more forecasts models associated with the one or more crowdsourcing platforms to determine a performance score of the schedule on each of the one or more forecast models; and
recommending, by the one or more processors, the schedule to a requestor based on the performance score.

2. The method of claim 1 further comprising determining, by the one or more processors, a confidence score for the schedule based on the performance score and a predetermined threshold.

3. The method of claim 1 further comprising ranking, by the one or more processors, the schedule with respect to other schedules, generated for other forecast models, based on an aggregation of the performance score of the schedule on each of the one or more forecast models, wherein the other forecast models are different from the forecast model.

4. The method of claim 1 further comprising receiving, by the one or more processors, an input from the requestor indicative of a selection of the schedule for processing of the batch of tasks.

5. The method of claim 4 further comprising sending, by the one or more processors, the batch of tasks to the one or more crowdsourcing platforms based on the schedule.

6. The method of claim 5 further comprising updating, by the one or more processors, the historical data associated with each of the one or more crowdsourcing platforms based on a performance of the one or more crowdsourcing platforms while processing of the batch of tasks.

7. The method of claim 1, wherein the historical data associated with a crowdsourcing platform corresponds to one or more mathematical models representing a performance of the crowdsourcing platform over a period of time.

8. The method of claim 1, wherein the one or more parameters associated with the batch of tasks comprise at least one of an expected task accuracy, a batch cost, an expected task completion time, or an expected batch completion time.

9. The method of claim 1, wherein the performance score corresponds to at least one of a task accuracy, a task completion time, or a task cost.

10. A system for scheduling a batch of tasks on one or more crowdsourcing platforms, the system comprising:
one or more processors operable to:
generate one or more forecast models for each of the one or more crowdsourcing platforms based on historical data associated with each of the one or more crowdsourcing platforms and a robustness parameter,
for a forecast model, from the one or more forecast models, associated with each of the one or more crowdsourcing platforms:
generate a schedule based on the forecast model and one or more parameters associated with the batch of tasks, wherein the schedule is deterministic of the processing of the batch of tasks on the one or more crowdsourcing platforms,
execute the schedule on each of the one or more forecasts models associated with the one or more crowdsourcing platforms to determine a performance score of the schedule on each of the one or more forecast models, and
recommend the schedule to a requestor based on the performance score.

11. The system of claim 10, wherein the one or more processors are further operable to determine a confidence score for the schedule based on the performance score and a predetermined threshold.

12. The system of claim 10, wherein the one or more processors are further operable to rank the schedule with respect to other schedules, generated for other forecast models, based on an aggregation of the performance score of the schedule on each of the one or more forecast models, wherein the other forecast models are different from the forecast model.

13. The system of claim 10, wherein the one or more processors are further operable to receive an input from the requestor indicative of a selection of the schedule for processing of the batch of tasks.

14. The system of claim 13, wherein the one or more processors are further operable to send the batch of tasks to the one or more crowdsourcing platforms based on the schedule.

15. The system of claim 14, wherein the one or more processors are further operable to update the historical data associated with each of the one or more crowdsourcing platforms based on a performance of the one or more crowdsourcing platforms while processing of the batch of tasks.

16. The system of claim 10, wherein the historical data associated with a crowdsourcing platform corresponds to one or more mathematical models representing a performance of the crowdsourcing platform over a period of time.

17. The system of claim 10, wherein the one or more parameters associated with the batch of tasks comprise at least one of an expected task accuracy, a batch cost, an expected task completion time, or an expected batch completion time, wherein the performance score corresponds to at least one of a task accuracy, a task completion time, or a task cost.

18. A computer program product for use with a computing device, the computer program product comprising a non-transitory computer readable medium, the non-transitory computer readable medium stores a computer program code for scheduling a batch of tasks on one or more crowdsourcing platforms, the computer program code is executable by one or more processors in the computing device to:
generate one or more forecast models for each of the one or more crowdsourcing platforms based on historical data associated with each of the one or more crowdsourcing platforms and a robustness parameter;
for a forecast model, from the one or more forecast models, associated with each of the one or more crowdsourcing platforms:
generate a schedule based on the forecast model and one or more parameters associated with the batch of tasks, wherein the schedule is deterministic of the processing of the batch of tasks on the one or more crowdsourcing platforms;
execute the schedule on each of the one or more forecasts models associated with the one or more crowdsourcing platforms to determine a performance score of the schedule on each of the one or more forecast models; and
recommend the schedule to a requestor based on the performance score.

19. The computer program product of claim 18, wherein the computer program code is further executable by the one or more processors to determine a confidence score for the schedule based on the performance score and a predetermined threshold.

20. The computer program product of claim 18, wherein the computer program code is further executable by the one or more processors to rank the schedule with respect to other schedules, generated for other forecast models, based on an aggregation of the performance score of the schedule on each of the one or more forecast models, wherein the other forecast models are different from the forecast model.
